(19) United States
(12) Patent Application Publication
(10) Pub. No.: US 2012/0303854 A1
(43) Pub. Date: Nov. 29, 2012

(54) MODULAR INTERFACE-INDEPENDENT STORAGE SOLUTION SYSTEM

(75) Inventor: MURAT KARSLIOGLU, Santa Clara, CA (US)

(73) Assignee: Raidundant LLC, Los Angeles, CA (US)

(21) Appl. No.: 13/480,340

(22) Filed: May 24, 2012

Related U.S. Application Data
(60) Provisional application No. 61/489,609, filed on May 24, 2011.

(51) Int. Cl. G06F 13/36

(52) U.S. Cl. 710/306

(57) ABSTRACT

A storage system provides a modular interface-independent architecture. The storage system includes multiple of storage devices removably coupled to a backplane. The backplane is configured to receive the signals from the storage devices, and separate the received signals into groups of power and data signals. The backplane is further configured to modify the second data signals to include information describing storage devices associated with the data signals, and convert the data signals into a predetermined interface technology signal format. The storage system also includes a bridge configured to modify the converted data signals to remove information describing storage devices associated with the data signals. The bridge is further configured to group the modified converted data signals into multiple data blocks and assign each of the plurality of data blocks to an output port of the bridge.

### CROSS REFERENCE TO RELATED APPLICATIONS

This application claims the benefit of U.S. Provisional Application No. 61/489,609, filed May 24, 2011, which is incorporated by reference in its entirety.

### BACKGROUND

1. Field of Art

The disclosure generally relates to the field of computer data storage systems.

2. Description of the Related Art

Demand for increased data storage continues to grow exponentially, driven by demands for media-rich content and a shift to cloud computing. This exponential growth presents challenges of scale, capacity, and mobility. Storage solutions include storage devices that determine the storage capacity of the storage system and storage interfaces that determine the overall data transfer rate between the storage subsystem and the host computing system. Storage interfaces vary based on interface technology. Each interface technology having varying bandwidth, latency, and interface characteristics, supported by different interface hardware and/or firmware.

But, as the initial requirements of the host system change, scaling such a system to meet increased performance typically requires replacing the entire storage systems to accommodate new hardware and firmware to support new interface technologies. And, in scaling such a system to meet increased capacity requirements, data center operators want more storage capacity in a reduced physical size to conserve valuable rack space. Furthermore, as storage systems increase storage capacity, the mobility of these systems decreases. Physically transporting storage devices is often technically infeasible because most storage devices are tightly integrated with the storage system. Electronically transporting large amounts of data requires a suitable network connection, which in some cases, is unavailable. Limited, current storage solutions are costly to scale in terms of performance and capacity, and provide limited options to physically transport large amounts of data.

### BRIEF DESCRIPTION OF DRAWINGS

The disclosed embodiments have other advantages and features which will be more readily apparent from the detailed description and the accompanying figures (or drawings). A brief introduction of the figures is below.

FIG. 1 illustrates one embodiment of components of a modular interface-independent storage solution system architecture.

FIG. 2 is a block diagram illustrating components of an example machine able to read instructions from a machine-readable medium and execute them in a processor (or controller).

FIG. 3 illustrates a block diagram of the functional architecture of one embodiment of a modular interface-independent storage solution system.

FIG. 4 illustrates in greater detail a block diagram of the functional architecture of one embodiment of a modular interface-independent storage solution system.

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### System Architecture

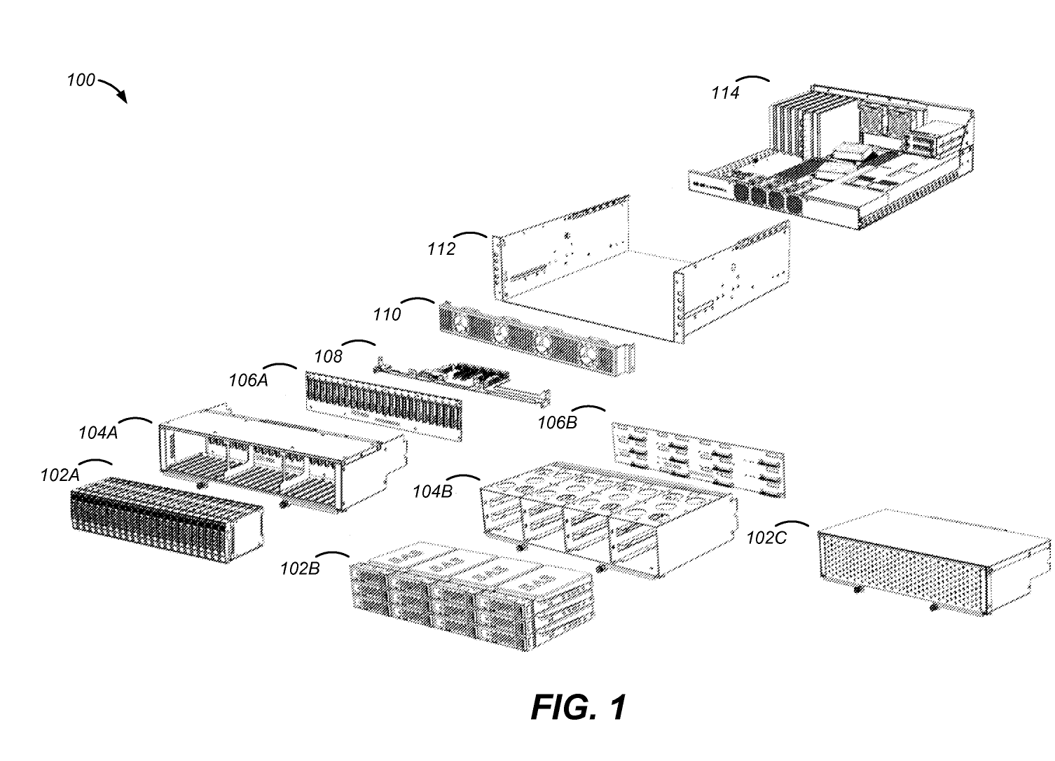

FIG. 1 illustrates one embodiment of components of a modular interface-independent storage solution system architecture 100, referred to hereinafter as storage solution system architecture 100. The storage solution system architecture 100 comprises storage device carrier 102, storage device array assembly 104, backplane 106, universal bridge 108, ventilation system 110, chassis 112, and subassembly 114.

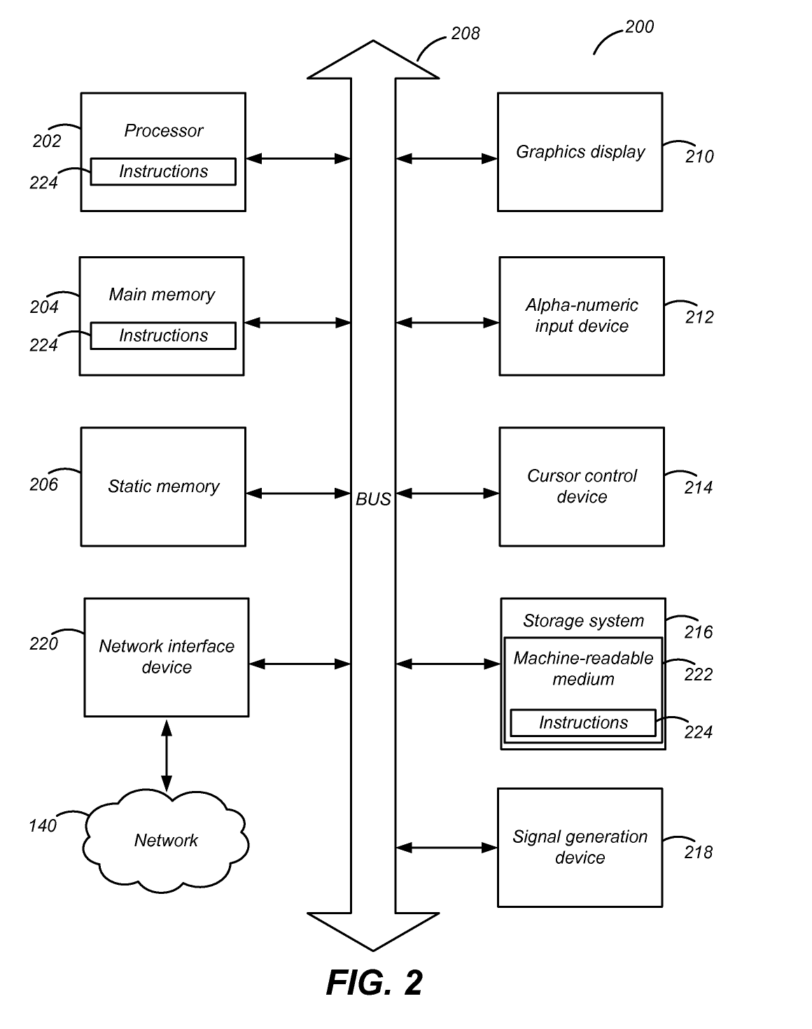

The storage device carrier 102 is a physical structure configured to house a machine readable medium for storing electronic data, as further described with FIG. 2 below. The storage device carrier 102 may have dimensions of a variety of sizes suitable to receive machine-readable medium having a variety of sizes. For example, the storage device carrier 102 may be configured to receive 2.5-inch, 3.5-inch, or other storage device form factors. The storage device carrier 102 may be configured to receive a variety of storage device types such as those described with FIG. 2.

Storage device carrier 102 includes one or more electromechanical connections for receiving control, power, and data signals from a machine-readable medium. In operation, a machine-readable medium may be removably coupled to the storage device carrier 102, and the storage device carrier 102 may be removably coupled to the storage device array assembly 104. The storage device carrier 102 may be removed from or added to the storage device array assembly 104 while the storage solution system is operating, without negatively impacting the operation of the storage solution system. The storage device carrier 102 may include one or more latches, levers, or release tabs that are operable to release the storage device carrier 102 from the storage device array assembly 104 or to hold the storage device carrier 102 in the storage device array assembly 104.

Multiple storage device carriers 102, each including a storage device, may be physically and functionally organized as an array to be received by storage device array assembly 104. For example, an array of storage device carriers 102A includes twenty-four carriers with a 2.5-inch form factor, each of the storage device carriers 102 lined-up next to one another. In another example, an array of storage device carriers 102B includes twelve carriers with 3.5-inch form factor, stacked or layered in groups of three, and each group of three lined-up next to one another. And in a further example, a storage device carrier 102C includes multiple solid state storage devices integrated into a storage device array assembly. The storage device carrier 102C may be a of a variety of sizes, including a 2U (2 rack units), or other sizes suitable to meet the constraints of the system environment.

The storage device array assembly 104 is a physical structure configured to receive one or more storage device carriers 102. The storage device array assembly 104 includes multiple drive bays, each drive bay or slot configured to receive a storage device carrier 102. For example, the storage device array assembly 104A may include twenty-four bays configured to receive 2.5-inch device carriers, and the storage device array assembly 104B includes twelve bays configured to receive 3.5-inch device carriers. Each drive bay of the storage device array assembly 104 includes an opening suitable to receive a storage device carrier 102, and a storage device carrier connector affixed to a front facing surface of a rear wall of the storage device array assembly 104. The storage device carrier connector is configured to removably couple the storage device carrier 102 to the storage device array assembly 104. The storage device carrier connectors are configured to be compatible with the storage device included in the storage device carrier 102 received by the storage device array assembly 104. The storage device array assembly 104 may include multiple storage device carrier connector types associated with each drive bay to support different storage device types. The storage device array assembly also includes corresponding backplane connectors on the rear facing surface of the rear wall of the storage device array assembly 104, configured to electrically couple the control, power, and data signals from each storage device carrier 102 to the backplane 106. The backplane connectors affixed to the storage device array assembly 104 are configured to removably couple the storage device array assembly 104 to the backplane 106. By doing so, the entire storage array assembly may be easily removed from storage solution system.

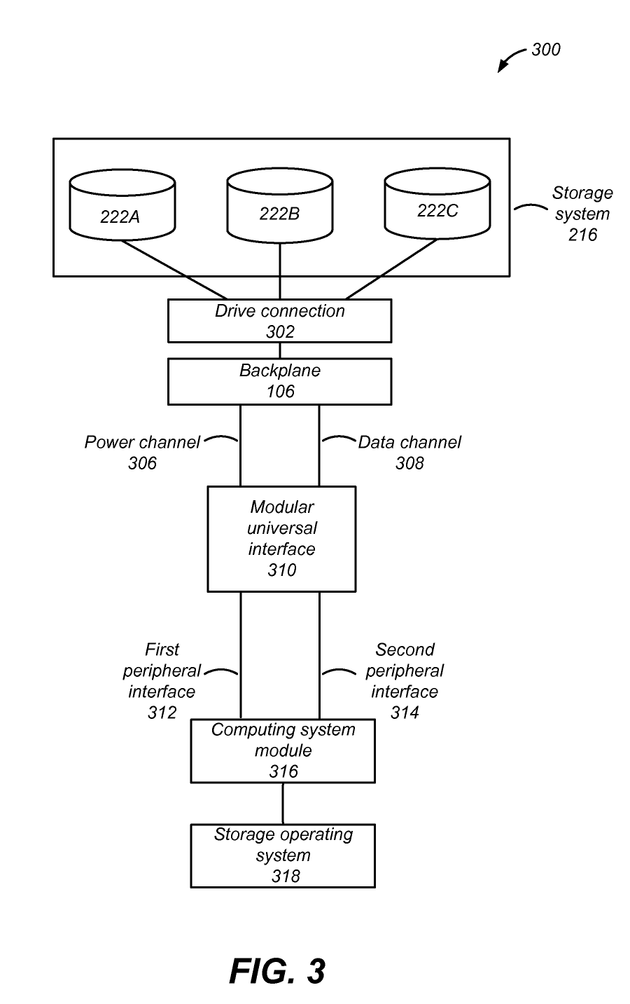

The backplane 106 is removably coupled to the storage device array assembly 104, and includes multiple connectors to receive the output of the storage device array assembly 104. The backplane 106, as will be described with FIG. 3, includes components to separate the power signals received from each storage device carrier 102 from the data signals received from each storage device carrier 102. The backplane 106 also includes multiple output connectors for outputting the separated power and data signal from each storage device carrier 102 housed in the storage device array assembly 104 to the universal bridge 108.

The universal bridge 108 is removably coupled to the backplane 106 using a pair of input connectors for receiving the separated power and data signals from the backplane 106. The pair of connectors may be a cable-less connector type, such as an edge connector, plug and socket connector, or any suitable cable-less connection. The universal bridge 108 also includes one or more components configured to format or convert the received data signals from each storage device carrier 102 into a signal format consistent with a predetermined interface technology type as described with FIG. 3 below. To output the converted data signals, the universal bridge 108 includes a pair of output connectors, each connector removably coupled to a subassembly 114.

The subassembly 114 includes ventilation system 110, chassis 112, and a computing system for processing data signals from each storage device carrier 102. The computing system as described with FIG. 3, is removably coupled to the universal bridge 108 through pair of redundant transmission channels, and a pair of corresponding connectors affixed to the computing system included in the subassembly 114. Furthermore, the subassembly 114 is physically arranged to receive a storage device array assembly 104 at location above the ventilation system 110. The ventilation system 110 is configured to provide sufficient air flow to maintain a temperature within the storage system suitable for proper operation of the computing device and the other components shown in FIG. 1.

### Computing System Overview

FIG. 2 is a block diagram illustrating components of an example machine able to read instructions from a machine-readable medium and execute them in a processor (or controller). The machine components disclosed herein can be incorporated into storage system architecture described in FIG. 1 and with the components described with FIG. 3 below. The example machine described corresponds to the machines (or computing systems) coupled to store data in and access data from storage system 216. FIG. 2, in particular, shows a diagrammatic representation of a machine in the example form of a computer system 200 within which instructions 224 (e.g., software) for causing the machine to perform any one or more of the methodologies discussed herein may be executed. In alternative embodiments, the machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment.

The machine may be a server computer, a client computer, a personal computer (PC), a web appliance, a network router, switch or bridge, or any machine capable of executing instructions 224 (sequential or otherwise) that specify actions to be taken by that machine. Further, while only a single machine is illustrated, the term “machine” shall also be taken to include any collection of machines that individually or jointly execute instructions 224 to perform any one or more of the methodologies discussed herein.

The example computer system 200 includes a processor 202 (e.g., one or more central processing units (CPU), a graphics processing unit (GPU), a digital signal processor (DSP), one or more application specific integrated circuits (ASICs), one or more radio-frequency integrated circuits (RFICs), or any combination of these), a main memory 204, and a static memory 206, which are configured to communicate with each other via a bus 208. One or more of the processor 202, the main memory 204, and the static memory 206 may be located on computing system module 316, as will be discussed with reference to FIG. 3. The computer system 200 may further include graphics display unit 210 (e.g., a plasma display panel (PDP), a liquid crystal display (LCD), a projector, or a cathode ray tube (CRT)). The computer system 200 may also include alphanumeric input device 212 (e.g., a keyboard), a cursor control device 214 (e.g., a mouse, a trackball, a joystick, a motion sensor, or other pointing instrument), a storage system 216, a signal generation device 218 (e.g., a speaker), and a network interface device 220, which also are configured to communicate via the bus 208.

The storage system 216 includes a machine-readable medium 222 on which is stored instructions 224 (e.g., software) embodying any one or more of the methodologies or functions described herein. The machine-readable medium 222 may be housed in a storage device carrier 102 as described in FIG. 1. The instructions 224 (e.g., software) may also reside, completely or at least partially, within the main memory 204 or within the processor 202 (e.g., within a processor's cache memory) during execution thereof by the computer system 200. The main memory 204 and the processor 202 also constitute machine-readable media. The instructions 224 (e.g., software) may be transmitted or received over a network 226 via the network interface device 220.

While the machine-readable medium 222 is shown in an example embodiment to be a single medium, the term “machine-readable medium” should be taken to include a single medium or multiple media (e.g., a centralized or distributed database, or associated caches and servers) able to store instructions (e.g., instructions 124). For example, as shown in FIG. 3, the storage system 216 includes three storage devices 222A, 222B, and 222C, representing three individual machine-readable mediums 222. The term “machine-readable medium” shall also be taken to include any medium that is capable of storing instructions (e.g., instructions 224) for execution by the machine and that cause the machine to perform any one or more of the methodologies disclosed herein. The term “machine-readable medium” includes, but not be limited to, data repositories in the form of solid-state memories, optical media, and magnetic media.

### Storage System Functional Architecture

Referring now to FIG. 3, illustrated is a block diagram of the functional architecture of one embodiment of a modular interface-independent storage solution system, hereinafter referred to as the storage solution system 300. The storage solution system 300 includes a storage system 216, a drive connection 302, a backplane 106, a modular universal interface 308, a computing system 314, and a storage operating system 316.

The storage system 216 includes storage devices 222A, 222B, and 222C, as described in FIG. 2. The storage system 216 may include any number of storage devices of any type suitable to meet a spectrum of storage capacity and performance requirements of storage solution system 300. Drive types include both solid-state drives (SSD) and electromechanical storage devices that use moving mechanical components. Drive types may also vary in physical size or form factor. For example, one or more of devices 222A, 222B, and 222C may have a form factor of 2.5-inch, 3.5-inch, or other suitable form factor. Drive types also include storage devices having a variety of interface types or interconnect technology types to connect the storage device to a computing system module 316. For example, one or more of devices 222A, 222B, and 222C support interface types including, parallel interfaces or serial interfaces. Examples of supported parallel interfaces include Advanced Technology Attachment (ATA), Integrated Drive Electronics (IDE), and Small Computer System Interface (SCSI). Examples of supported serial interfaces include serial attached SCSI (SAS), Internet SCSI, Serial Advanced Technology Attachment (SATA), Fibre Channel, and Fibre Channel over Ethernet.

The drive connection 302 receives signals from the storage system 216 using one or more physical connectors compatible with interface types associated with storage devices 222A, 222B, and 222C. The drive connection 302 may be a printed circuit board, flexible substrate, or other structure suitable to mechanically and electrically connect electronic components using conductive pathways, channels, signal traces, or transmission lines. The drive connection 302 sends data and power signals received from the storage system 216 to the backplane 106 using one or more electromechanical connections. Such an electromechanical connection may be any connection suitable to reliably exchange signals between the storage system 216 and the computing system module 316 over the backplane 106.

The backplane 106 separates the power signals received from the storage system 216 from the data signals received from the storage system 216, and routes the separated power and data signal to a first and second output connector for transmission over from the power channel 306 and the data channel 308. In one embodiment, power and data signals may be routed from the drive connection 302 in a manner that physically separates the power signals of the respective storage devices of the storage system 216 from their associated data signals. In another embodiment, the backplane 106 may include electronic components configured to receive the incoming signals from the storage system 216, analyze the incoming signals, and determine whether the incoming signal is a power signal or a ground signal. For example, components used to make such a determination may be configured to detect specified parametric characteristics of a received signal, such as rise time, fall time, period, and frequency. In another example, components used to make such a determination may also be configured to evaluate a received signal using a test mask corresponding to a particular interface type.

In cases where the evaluation result indicates that the received signal is a power signal, the components route (e.g., using a multiplexer or switch) the power signal onto a first signal pathway or channel for power signals. In cases where the evaluation result indicates that the received signal is a data signal, the components route the data signal onto a second pathway for data signals.

The first signal pathway may be one or more signal traces or transmission lines suitable for routing the separated power signals across the backplane 106 for transmission across the power channel 306. Similarly, the second pathway may also include one or more signal traces or transmission lines suitable for routing the separated data signals across the backplane 106 for transmission across the data channel 308.

The second pathway also includes one or more components configured to reformat or modify the received data signals prior to transmission across the data channel 308. The backplane 106 reformats the received data signals by adding to the received data signals information describing the type of storage device and the number of storage devices included in the storage system 216. The resulting reformatted data is referred to herein after as packed data, and the native or unformatted data is referred to herein as unpacked data. For example, for a storage system 216 comprised of five SATA devices and five SAS devices, signals received from any one of the five SATA devices will be packaged along with information indicating the signal is from one of five SATA drives. The information describing the drive type and number of drives may be encoded using any alphanumeric or numeric encoding scheme suitable to transmit data across the data channel 308 and to be decoded by the modular universal interface 310. Once packaged, the backplane 106 converts the data signals to an SAS protocol format or other predetermined interface technology signal format for transmission to the modular universal interface 310.

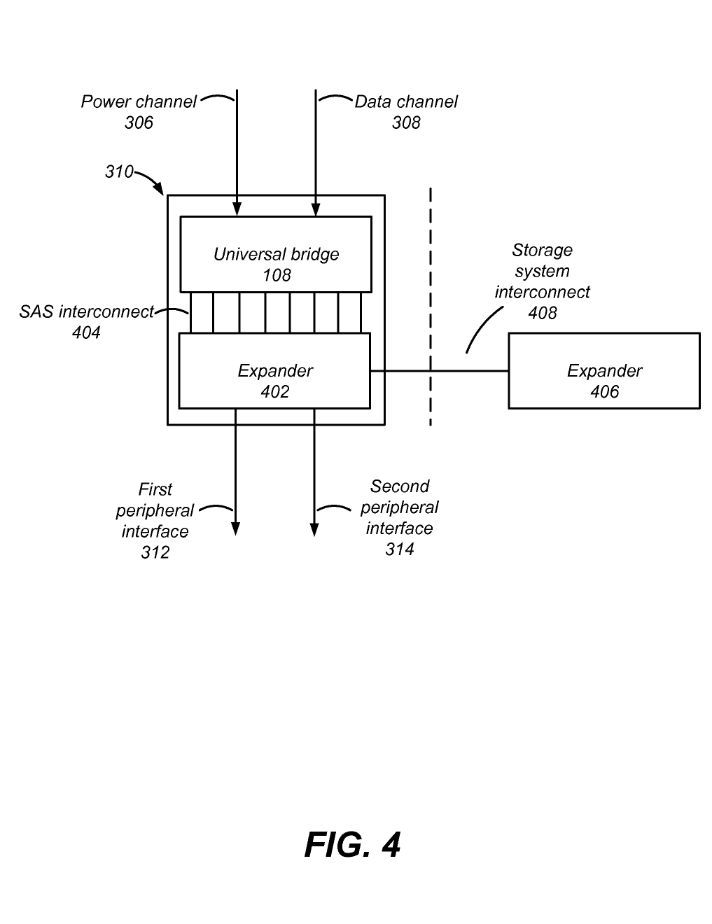

The modular universal interface 310 receives the power signal from the power channel 306 and the SAS formatted data signals from the data channel 308 at a first and second input port. As will be later described with respect to FIG. 4, the modular universal interface 310 outputs the SAS formatted data to the computing system module 316 over a first peripheral interface 312 and a second peripheral interface 314. The first 312 and the second 314 peripheral interface operating as redundant transmission pathways to carry the same data from the modular universal interface 310 to the computing system 316.

In one embodiment, the modular universal interface 310 outputs the SAS formatted data over both the first 312 and the second 314 peripheral interfaces at substantially the same time. In such a configuration, the first peripheral interface 312 may act as a primary interface, and the second peripheral interface 314 may act as a secondary interface, or vice versa. In another embodiment, the modular universal interface 310 outputs the SAS formatted data on the first peripheral interface 312 unless the modular universal interface 310 detects an interruption or fault in the transmission path across the first peripheral interface 312. When a fault is detected on the first peripheral interface 312, the modular universal interface 310 switches its output to the second peripheral interface 314. In one embodiment, the first 312 and second 314 peripheral interfaces may be a SAS cable or other transmission channel suitable to exchange information between the modular universal interface 310 and the computing system 316.

The computing system 316 receives the output of the modular universal interface 310, and converts the received SAS formatted data into a format associated with the native storage device interface type associated with a particular data signal. The computing system 316 may be a motherboard or system board configured to provide the electrical connections by which the other components of the computer system 200 communicate. The computing system 316 the sends the data signals from the storage system 216 to the storage operation system 318 for processing.

Turning now to FIG. 4, it illustrates in greater detail a block diagram of the modular universal interface 310 of one embodiment of a modular interface-independent storage solution system. The modular universal interface 310 includes a universal bridge 108 and an expander 402. In an embodiment, the universal bridge 108 may be a universal SAS bridge configured to convert incoming signals to a signaling format consistent with the SAS interface standard. In which case, the expanders 402 and 406 may be an SAS expander 402 and a SAS expander 406 configured to receive the SAS formatted output signals from a universal SAS bridge. Hereinafter, the description of the universal SAS bridge 108 also applies more generally to a universal bridge 108 configured to convert incoming data signals from storage device carrier 102 to an interface technology standard other than SAS. Similarly, the description of the SAS expanders 402 and 406 also applies more generally to an expander 402 and an expander 406 supporting an interface technology standard other than SAS and suitable to receive the output of the universal bridge 108.

The universal SAS bridge 108 has a first input configured to receive from the backplane 106, the power signals of the storage devices included in the storage system 216. The universal SAS bridge 108 also includes a second input configured to receive from the backplane 106, the packaged data signals of the storage devices included in the storage system 216. The packaged data signals are unpacked by the universal SAS bridge 108. The universal SAS bridge 108 may unpack the data signals by applying the reverse operation of the packing operation performed by the backplane 106. For example, to unpack a data signal, the universal SAS bridge 108 removes from the packed data signal the information describing the type of storage device and the number of storage devices included in the storage system 216, which was added to the data signal output from the storage system 216 by the backplane 106. In which case, the backplane 106 and the universal SAS bridge 108 may be preprogrammed with instructions and/or code for performing the packing and unpacking operations.

The universal SAS bridge 108 organizes the unpacked data into data blocks for transmission to the computing system 316. To output the data blocks, the universal SAS bridge 108 assigns each data block to be output from one of its output ports. Each output port of the universal SAS bridge having a bandwidth based on the available bandwidth of the SAS interconnect 404 coupled to each output port.

The universal SAS bridge 108 organizes the unpacked data into data blocks. Each data block comprised of data signals from a determined number of storage devices included in storage system 216. For example, a storage system comprised of sixteen storage devices may organized into four data blocks, each data block including the signals from four separate storage devices. Generally, the number of storage devices included in a data block is based at least in part on the bandwidth of the SAS interconnect 404 coupled to each output port of the universal SAS bridge 108. For example, to determine the appropriate block size (i.e., the number of storage devices), the universal SAS bridge 108 divides the bandwidth of the SAS interconnect 404 by a predetermined factor x, where x is a numerical value representing the bandwidth of an interface type of a particular storage device. To determine x, the universal SAS bridge 108 accesses the drive type information from information included in the packed data sent with each data signal. Using the identified drive type information, the universal SAS bridge 108 accesses a lookup table or similar data structure that stores drive type information and corresponding bandwidth of the interface type associated with the particular drive type. The lookup table may also include bandwidth information for each portion of the signal pathway between the universal SAS bridge 108 and the computing system 316.

Using the lookup table, the universal SAS bridge 108 may then calculate the number of drives associated with a data block by dividing the bandwidth of the SAS interconnect 404 by the value of x identified from the lookup table. The universal SAS bridge 108, in turn, assigns a data block to one output port of the universal SAS bridge 108 for output to SAS expander 402 using SAS interconnect 404. The universal SAS bridge 108 is configured to output data signals associated with data blocks in parallel on each output port of the universal SAS bridge 108. The data blocks are output in an order corresponding to the physical mapping of the storage devices in the storage system 216. For example, assume the storage system 216 that includes sixteen storage devices and that the universal SAS bridge 108 organized the storage devices into four data blocks—the first data block including signals from storage devices 0-3, the second data block including signals from storage devices 4-7, the third data block including signals from storage devices 8-11, and the fourth data block including signals from storage devices 12-15. The storage devices may be physically ordered in any suitable manner within a storage system. For example, the storage devices may be placed in physically sequential slots within the chassis of storage system 216, ordered from left to right beginning with drive 0 in the left most position and ending with drive 15 in the right most position.

To output the data signals to the SAS expander 402, the universal SAS bridge 108 maps the ordering of the physical storage devices to a logical ordering for output on output ports A-D of the universal SAS bridge 108. An example logical ordering of the data blocks for output on output ports A-D may map the first data block to port A, the second data block to port B, the third data block to port C, and the fourth data block to port D.

The SAS expander 402 receives the data signals output from the universal SAS bridge 108 and outputs the data over at least one of the first peripheral interface 312 or the second peripheral interface 314. In another embodiment, the SAS expander 402 receives the data signals output from the universal SAS bridge 108 and provides the data signals to an external port of a second computing system using storage system interconnect 408. The external port of the second computing system may be an input port of another SAS expander 406 included in another modular universal interface (not shown) of the second computer system. Thus the data signals from a storage system 216 may be accessible from another computing system using expanders, and thus, providing access to data in the event of a failure on the computing system 316.

### Additional Configuration Considerations

The disclosed configurations advantageously provide a scalable storage solution architecture capable of expanding to accommodate emerging storage interface technologies and increased demand for data storage capacity. The modular architecture accommodates changing storage interface technology requirements of the storage array by physically and functionally decoupling the storage interface requirements of the storage array from the computing system that processes the data stored on the storage array. Thus, a change in storage requirements can be accommodated by changing a single storage device or an entire a storage array without disrupting the interface between the computing system and the storage array. Furthermore, by the integration of the storage array and the computing device into a single chassis provides increased storage density per unit area.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms, for example, as noted with respect to FIGS. 1, 3, and 4. Modules may constitute either software modules (e.g., code embodied on a machine-readable medium or in a transmission signal) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

The various operations of example methods described herein may be performed, at least partially, by one or more processors, e.g., 202, that are temporarily configured (e.g., by software) or permanently configured to perform the relevant operations. Whether temporarily or permanently configured, such processors, e.g., 202, may constitute processor-implemented modules that operate to perform one or more operations or functions. The modules referred to herein may, in some example embodiments, comprise processor-implemented modules.

The one or more processors, e.g., 202, may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

The performance of certain of the operations may be distributed among the one or more processors, e.g., 202, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors, e.g., 202, or processor-implemented modules may be distributed across a number of geographic locations.

Some portions of this specification are presented in terms of algorithms or symbolic representations of operations on data stored as bits or binary digital signals within a machine memory (e.g., the computer memory 204). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a modular interface-independent storage solution system through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A system comprising:
a storage system comprising a plurality of storage devices;
a backplane configured to:
receive a plurality of signals from the storage system,
separate the plurality of signals into a first signal group and a second signal group,
modify the second signal group to include information describing storage devices associated with signals included in the second signal group, and
convert the second signal group to a predetermined interface technology signal format; and
a bridge configured to:
receive a converted second signal group,
modify the converted second signal group to remove information describing storage devices associated with signals included in the second signal group,
group the modified converted second signal group into a plurality of data blocks based at least in part on the information describing the storage devices associated with the signals included in the second signal group,
assign each of the plurality of data blocks to one of a plurality of output ports of the bridge; and
output each data block on one of the plurality of output ports of the bridge.

2. The system of claim 1, wherein the first signal group includes one or more power signals and the second signal group includes one or more data signals.

3. The system of claim 1, wherein information describing storage devices includes storage device type and a number of storage devices associated with second signal group.

4. The system of claim 1, wherein the bridge is configured to output each of the data blocks on one of the output ports of the bridge in an order corresponding to a physical mapping of the storage devices in the storage system.

5. The system of claim 1, wherein the predetermined interface technology signal format is a Serial Attached Small Computer System Interface (SAS) signal format.

6. The system of claim 1, wherein the bridge is a SAS bridge.
